(19) United States
(12) Patent Application Publication
(10) Pub. No.: US 2019/0122177 A1
(43) Pub. Date: Apr. 25, 2019

(54) DRONE DELIVERY ROUTING AND COMMUNICATION

(71) Applicant: International Business Machines Corporation, Armonk, NY (US)

(72) Inventors: BENJAMIN D. BRIGGS, Waterford, NY (US); LAWRENCE A. CLEVENGER, Rhinebeck, NY (US); LEIGH A. CLEVENGER, Rhinebeck, NY (US); CHRISTOPHER J. PENNY, Saratoga Springs, NY (US); MICHAEL RIZZOLO, Albany, NY (US); ALDIS G. SIPOLINS, New York, NY (US)

(21) Appl. No.: 15/787,814

(22) Filed: Oct. 19, 2017

(51) Int. Cl. G06Q 10/08; B64C 39/02; B60L 11/18; G08G 5/00

(52) U.S. Cl. CPC G06Q 10/08355; B64C 39/024; B64C 2201/128; G08G 5/0069; B64C 2201/208; B60L 11/1838

(57) ABSTRACT

A delivery system is provided. In the delivery system, drones deliver items in a serviced area and charging stations are distributed throughout the serviced area. Each charging station is configured to charge one or more of the drones. The delivery system further includes a processor that is communicative with at least the charging stations. The processor is configured to dynamically route delivery operations of each of the drones in accordance with one or more parameters. The processor is further configured to communicate with individuals involved with the delivery operations in accordance with any of the charging stations being associated with the delivery operations.

### BACKGROUND

The present invention generally relates to delivery systems, and more specifically, to cognitive drone delivery routing and communication systems.

Items purchased by customers are often delivered to those customers through various modes of transportation. These modes of transportation include, but are not limited to, shipping, rail and trucking. Recently, drones have been developed that allow for items to be delivered by drones. Drones are generally unmanned ground-based or aerial vehicles that can be launched from a base with an item or package and then driven or flown to a customer. Once the drone reaches the customer, the package can be delivered and the drone can return to the original base or proceed toward a next destination.

### SUMMARY

Embodiments of the invention are directed to a delivery system. A non-limiting example of the delivery system includes drones that deliver items in a serviced area and charging stations distributed throughout the serviced area. Each charging station is configured to charge one or more of each of the drones. The non-limiting example of the delivery system further includes a processor communicative with at least the charging stations. The processor is configured to dynamically route delivery operations of each of the drones in accordance with one or more parameters. The processor is further configured to communicate with individuals involved with the delivery operations in accordance with any of the charging stations being associated with the delivery operations.

In the non-limiting example of the delivery system, the drones variously deploy from and return to bases, trucks and warehouses.

In the non-limiting example of the delivery system, at least the charging stations are communicative with each other via one or more of WiFi and cellular networks.

In the non-limiting example of the delivery system, one or more of the charging stations is modular.

In the non-limiting example of the delivery system, the processor includes one or more of computing resources distributed throughout at least the charging stations and a central server.

In the non-limiting example of the delivery system, the delivery operations include pre-delivery and post-delivery drone travel, the one or more parameters include cost minimization and productivity maximization parameters and communication between the processor and the individuals includes deliveries of financial incentives calculated in accordance with charging station value in the serviced area.

In the non-limiting example of the delivery system, the processor is further configured to calculate additional financial incentives to be offered to potential owners of additional charging stations and to offer the additional financial incentives to the potential owners to facilitate growth of the network.

Embodiments of the invention are directed to an item delivery system. A non-limiting example of the item delivery system includes drones that deliver items to customers residing in a serviced area and a network of communicative charging stations distributed throughout the serviced area. Each charging station is configured to charge one or more of each of the drones. The non-limiting example of the item delivery system further includes a processor. The processor includes one or more of computing resources distributed throughout at least the charging stations and a central server. The processor is communicative with at least the charging stations and is configured to dynamically route pre-delivery and post-delivery operations of each of the drones in accordance with one or more parameters and to communicate with individuals involved with the pre-delivery and the post-delivery operations and with operators of at least a portion of those charging stations which are associated with the pre-delivery and the post-delivery operations.

The non-limiting example of the item delivery system can also include bases, trucks and warehouses from which the drones are variously deployed and to which the drones variously return.

In the non-limiting example of the item delivery system, at least the charging stations are communicative with each other via one or more of WiFi and cellular networks.

In the non-limiting example of the delivery system, one or more of the charging stations is modular.

In the non-limiting example of the delivery system, the one or more parameters include cost minimization and productivity maximization parameters and communication between the processor and the individuals and the operators includes deliveries of financial incentives calculated in accordance with charging station value in the serviced area.

In the non-limiting example of the delivery system, the processor is further configured to calculate additional financial incentives to be offered to potential owners of additional charging stations and to offer the additional financial incentives to the potential owners to facilitate growth of the network.

Embodiments of the invention are directed to a method of operating an item delivery system. A non-limiting example of the drone delivery system includes drones to deliver items in a serviced area and a network of charging stations distributed throughout the serviced area. Each charging station is configured to charge at least one of each of the drones. The non-limiting example of the drone delivery system further includes a processor communicative with at least the charging stations. A non-limiting example of the method is executable by the processor. The non-limiting example of the method includes dynamically routing pre-delivery and post-delivery operations of each of the drones in accordance with one or more parameters. The non-limiting example of the method further includes communicating with individuals involved with the pre-delivery and the post-delivery operations in accordance with any of the charging stations being associated with the pre-delivery and the post-delivery operations.

The non-limiting example of the method can also include variously deploying the drones from bases, trucks and warehouses and variously returning the drones to the bases, trucks and warehouses.

The non-limiting example of the method can also include establishing communications between at least the charging stations and a central server via one or more of WiFi and cellular networks.

In the non-limiting example of the method, the one or more parameters includes cost minimization and productivity maximization parameters and the communicating includes delivering financial incentives calculated in accordance with charging station value in the serviced area.

The non-limiting example of the method can also include calculating additional financial incentives to be offered to potential owners of additional charging stations and offering the additional financial incentives to the potential owners to facilitate growth of the network.

Embodiments of the invention are directed to a computer program product for operating an item delivery system that includes drones to deliver items in a serviced area and a network of charging stations distributed throughout the serviced area. Each charging station is configured to charge one or more of each of the drones. The computer program product includes memory on which executable instructions are stored and a processing circuit which is communicative with at least the charging stations and configured to execute the executable instructions to perform a method. The method includes dynamically routing pre-delivery and post-delivery operations of each of the drones in accordance with one or more parameters. The method further includes communicating with individuals involved with the pre-delivery and the post-delivery operations in accordance with any of the charging stations being associated with the pre-delivery and the post-delivery operations.

The non-limiting example of the method can also include variously deploying the drones from bases, trucks and warehouses and variously returning the drones to the bases, trucks and warehouses.

The non-limiting example of the method can also include establishing communications between at least the charging stations and a central server via one or more of WiFi and cellular networks.

In the non-limiting example of the method, the one or more parameters include cost minimization and productivity maximization parameters and the communicating includes delivering financial incentives calculated in accordance with charging station value in the serviced area.

The non-limiting example of the method can also include calculating additional financial incentives to be offered to potential owners of additional charging stations and offering the additional financial incentives to the potential owners to facilitate growth of the network.

Embodiments of the invention are directed to a method of operating and growing a network of charging stations for a drone delivery system. A non-limiting example of the method includes distributing charging stations throughout an area serviced by the drone delivery system and dynamically routing pre-delivery and post-delivery drone operations in accordance with one or more parameters. The non-limiting example of the method further includes delivering financial incentives to individuals involved with the pre-delivery and the post-delivery drone operations in accordance with any of the charging stations associated with the pre-delivery and the post-delivery drone operations. In addition, the non-limiting example of the method includes calculating additional financial incentives to be offered to potential owners of additional charging stations which can increase an effective range or improve a performance of the drone delivery system and offering the additional financial incentives to the potential owners to facilitate growth of the network.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a drone delivery system in accordance with embodiments of the invention;

FIG. 2 is a schematic diagram illustrating computing resources of the drone delivery system of FIG. 1 in accordance with embodiments of the invention;

FIG. 3 is a schematic illustration of a drone charging station of the drone delivery system of FIGS. 1 and 2 in accordance with embodiments of the invention;

FIG. 4 depicts a drone delivery scenario of the drone delivery system of FIGS. 1 and 2 in accordance with embodiments of the invention;

FIG. 5 depicts a drone delivery scenario of the drone delivery system of FIGS. 1 and 2 in accordance with embodiments of the invention;

FIG. 6 is a flow diagram illustrating a method of operating the drone delivery system of FIGS. 1 and 2 in accordance with embodiments of the invention;

FIG. 7 is a flow diagram illustrating a method of operating the drone delivery system of FIGS. 1 and 2 in accordance with embodiments of the invention; and

FIG. 8 is a flow diagram illustrating a method of operating and growing a network of charging stations of a drone delivery system in accordance with embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments of the invention or designs. The terms “at least one” and “one or more” can be understood to include any integer number greater than or equal to one, i.e. one, two, three, four, etc. The terms “a plurality” can be understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, a delivery drone is an unmanned ground-based or aerial vehicle (UAV) that is utilized to transport packages, food or other goods from one location, such as a warehouse, to a second location, such as a place where a customer resides. While the delivery drone can be ground-based or aerial, the following description will generally relate to delivery drones or simply “drones” as being unmanned UAVs for the purposes of clarity and brevity.

Thus, in a given item or package delivery system using only drones for deliveries, a range of the delivery system is dependent upon the range of the individual drones the delivery system employs. That is, if the drones have only a 100 mile range and the delivery system has only a single drone charging station, the delivery system can have only slightly less than a 50 mile radius because the drones will use up half their range capabilities during pre-delivery travel of the outbound portion of the trip and the rest of their range on the post-delivery travel of the return portion of trip.

Many delivery systems therefore incorporate multiple warehouses from which drones can leave from and return to, trucks that provide for mobile bases, and in some instances a loosely defined network of charging stations. The charging stations in particular can be distributed throughout the area serviced by the delivery system and are configured to charge the drones whenever such charge is needed. Therefore, in the example given above, if additional drone charging stations are provided and dispersed 50 miles away from the original single drone charging station, the area serviced by the 100 mile range drones will be effectively increased to a further 50 miles beyond each of the additional drone charging stations.

Even with the additional drone charging stations, delivery systems relying on drones continue to exhibit drawbacks. These include, in particular, the fact that the drones and the drone charging stations do not typically communicate with each other or with a central server. Thus, dynamic routing of the drones throughout the service area of the delivery systems is impossible. In addition, the growth of the network of charging stations is typically slow and dependent on the ability of the delivery system to purchase land on which its own drone charging stations can be installed. Moreover, the growth of the network often fails to target certain remote areas even if potential customers reside in those areas.

Turning now to an overview of the aspects of the invention, one or more embodiments of the invention address the above-described shortcomings of the prior art by providing for a delivery system including a network of drone charging stations that are communicative with at least each other and in some cases with drones and a processor. Such communications allow for dynamic routing of the drones throughout the area serviced by the delivery system and in turn provide for cost-minimization and productivity maximization. The processor of the delivery system is also configured to calculate financial incentives for operators of at least a portion of those charging stations which are associated with delivery operations so as to encourage the growth of the network of the drone charging stations.

The above-described aspects of the invention address the shortcomings of the prior art by providing for a delivery system with an extensive network of interconnected drone charging stations in which delivery operations of its drones are dynamically routed and therefore inexpensive to operate and relatively highly productive. Moreover, the incentives provided to owners of certain drone charging stations encourage the growth of the delivery system by encouraging additional individuals to install additional drone charging stations into the network beyond what would be possible otherwise.

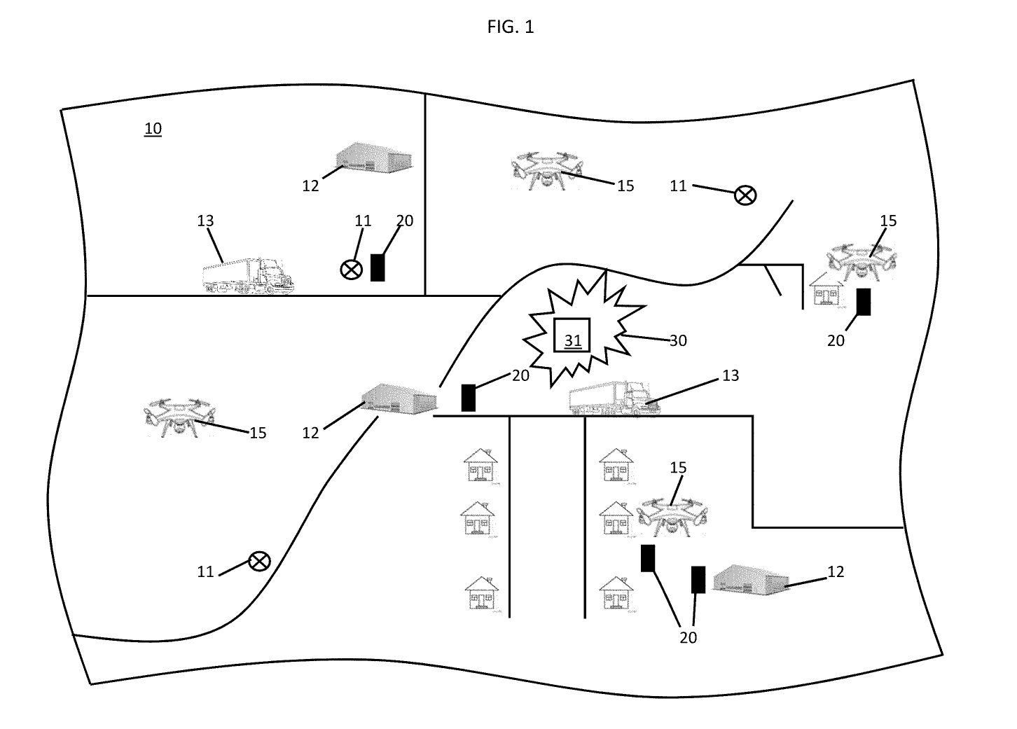

Turning now to a more detailed description of aspects of the present invention, FIG. 1 depicts a drone delivery system 10 in accordance with embodiments of the invention. As shown in FIG. 1, the drone delivery system 10 services an area of land in which customers of the drone delivery system 10 reside permanently (e.g., in houses) or temporarily (e.g., in campgrounds). The area of land can have various topographical features, including flat or hilly regions as well as dry or wetlands, and population centers or rural areas. The area of land can further include multiple highways, local roads and pathways as well as areas that are not reachable by waterways or roadways but which are nevertheless occupied by potential customers.

The drone delivery system 10 can include multiple bases 11, such as helipads or roof-top landing pads, warehouses 12 distributed at various locations throughout the area of land for maintaining an inventory of products to be delivered to customers upon order, and multiple trucks 13 that can move through the area of land to perform deliveries or to support delivery operations. The drone delivery system 10 can also include a fleet of drones 15. The fleet of drones 15 are configured to delivery items or packages (hereinafter referred to as “packages”) to any customer residing permanently or temporarily in the area of land. To that end, the drones 15 can be variously deployed from any of the bases 11, the warehouses 12 and the trucks 13 with a package to be delivered and can then variously return to any of the bases 11, the warehouses 12 and the trucks 13 once delivery is complete so that they can pick up a new package for delivery.

In accordance with embodiments of the invention and as will be discussed below, the drones 15 need not return to a same one of the bases 11, the warehouses 12 or the trucks 13 that they leave from. Rather, they can be dynamically routed toward whichever one of those elements is most cost-effective and productive.

The drone delivery system 10 can further include a network of communicative drone charging stations 20 and a cognitive entity or a processor (hereinafter referred to as a “processor”) 30.

The network of drone charging stations 20 is distributed throughout the serviced area of land. Each drone charging station 20 is communicative at least with each other via one or more of WiFi and/or cellular networks. In addition, each drone charging station is configured to charge one or more of each of the drones 15. Such charging can provide each of the drones 15 with a full power supply or at least an increased power supply as compared to what it had previously and can effectively increase a range of the charged drone 15. As will be described below, each drone charging station 20 can be modular and can charge one or more various types of drones 15 sequentially or simultaneously.

The processor 30 can be communicative with at least the drone charging stations 20 and, in some cases, with the drones 15 as well. The processor 30 can be provided as a distributed network of at least one of computing resources which can be distributed throughout the serviced area of land, the drone charging stations 20 and/or a central server 31.

In any case, the processor 30 is configured to dynamically route pre-delivery operations and post-delivery operations of each of the drones 15 in accordance with one or more parameters. The processor 30 is further configured to calculate financial incentives for and to delivery such financial incentives to individuals involved with the pre-delivery operations and the post-delivery operations (i.e., customers). The processor 30 is also configured to calculate financial incentives for and to deliver such financial incentives to operators of at least a portion of the charging stations 20 that are associated with the pre-delivery operations and the post-delivery operations (i.e., those operators of drone charging stations 20 that are used to charge a given drone 15 on a given delivery operation).

In accordance with further embodiments of the invention, the processor 30 can also be configured to calculate additional financial incentives to be offered to potential owners of additional drone charging stations 20 that might be added to the network and to then offer those calculated additional financial incentives to the potential owners to thereby facilitate growth of the network.

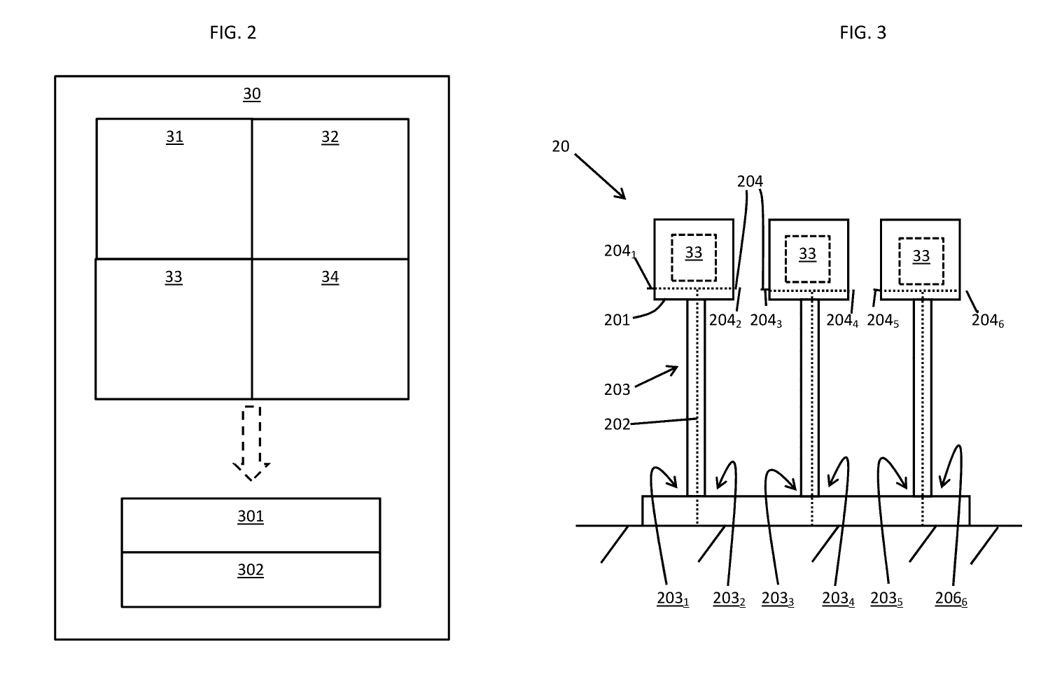

With reference to FIG. 2, the processor 30 can be provided as a computer program product or as a network of interconnected and communicative computing resources. In either case, in accordance with embodiments of the invention, the processor 30 can include the central server 31 as well as processing units 32 and 33 of each of the drones 15 and the drone charging stations 20, respectively, and processing units of remote servers or client computers 34. The processor 30 thus includes a memory unit 301 and a processing circuit 302, which are each embodied in storage and processing capabilities of the central server 31, the processing units 32 and 33 and the remote servers or client computers 34. The memory unit 301 includes or has executable instructions stored thereon. The processing circuit 302 is configured to execute the executable instructions of the memory unit 301 such that the processing circuit 302 is caused to perform the methods and operations described herein.

With reference to FIGS. 3, the drone charging stations 20 generally include a housing 201 which houses the processing unit 33, a connection 202 to an external power source, such as alternative current (AC) of an electrical grid, a docking bay 203 in which a drone 15 can be seated for charging operations, a charging connector 204 and a networking unit 205 by which communications with other drone charging stations 20 and/or other features of the processor 30 are possible. The charging connector 204 is connectable to the drone 15 (shown in FIG. 1) for engaging the charging operations. The charging connector 204 can be provided as a standard connector, such as a MagSafe™ connector or a USB connector, or can be provided as a wireless charger that charges the seated drone 15 by way of induction charging. In the latter case, the drone charging station 20 can also include an induction coil that can be sized for charging various sizes of drones 15. In some cases, the charging connector 204 can mate which a port of the seated drone 15 or can be provided as a port that mates with a cable of the seated drone 15.

In accordance with embodiments of the invention, as shown in FIG. 3, one or more of the drone charging stations 20 can be provided as a modular drone charging station. In such cases, the capacity of the drone charging station 20 can be relatively increased by increasing for example a number of docking bays 203 such that the drone charging station 20 includes first-nth docking bays 203₁₋ₙ and/or by increasing a number and/or type of the charging connectors 204 such that the drone charging station 20 includes first-nth charging connectors 204₁₋ₙ for each of the first-nth docking bays 203₁₋ₙ.

In accordance with embodiments of the invention, the one or more parameters by which pre-delivery and post-delivery operations are dynamically routed can include cost minimization parameters and productivity maximization parameters. More particularly, the one or more parameters can include availabilities, charge conditions and ranges of the drones 15, availabilities of drone charging stations 20, customer priority drawn from order sequence and/or customer contracts, weather and topographical conditions, etc. Meanwhile, the financial incentives that can be delivered to the individuals involved with the delivery operations as customers or as owners of drone charging stations 20 that are associated with the pre-delivery or post-delivery operations can be calculated by the processor 30 in accordance with at least a value of the drone charging station 20 with in the serviced area. More particularly, the value of the drone charging station 20 can be determined by the processor 30 from its effect on network coverage (i.e., how if at all does the drone charging station 20 increase an area of the delivery system 10), its effect on network density (i.e., how many other drone charging stations 20 are in the local area relative to population density), its effect on network connectedness (i.e., how if at all does the drone charging station 20 bridge clusters of other drone charging stations 20 together) and its change in costs or time per delivery relative to truck delivery or previous delivery costs or times in the affected network area.

In accordance with embodiments of the invention, the additional financial incentives that can be calculated and then offered to potential owners can include a one-time reimbursement for the drone charging station 20 (up to and exceeding the cost of the station), discounts on delivery charges (up to and including the full cost of drone delivery) and store credit. As above, the nature and size of the incentives can be calculated or determined in accordance with an expected or predicted value of the drone charging station 20 if it were added to the network. The expected or predicted value of the drone charging station 20 can be determined by the processor 30 from its expected or predicted effect on network coverage (i.e., how if at all will the drone charging station 20 increase an area of the delivery system 10), its expected or predicted effect on network density (i.e., how many drone charging stations 20 are already in the local area relative to population density), its potential expected or predicted effect on network connectedness (i.e., how if at all will the new drone charging station 20 bridge clusters of other drone charging stations 20 together) and its potential expected or predicted change in costs or time per delivery relative to truck delivery or previous delivery costs or times in the affected network area.

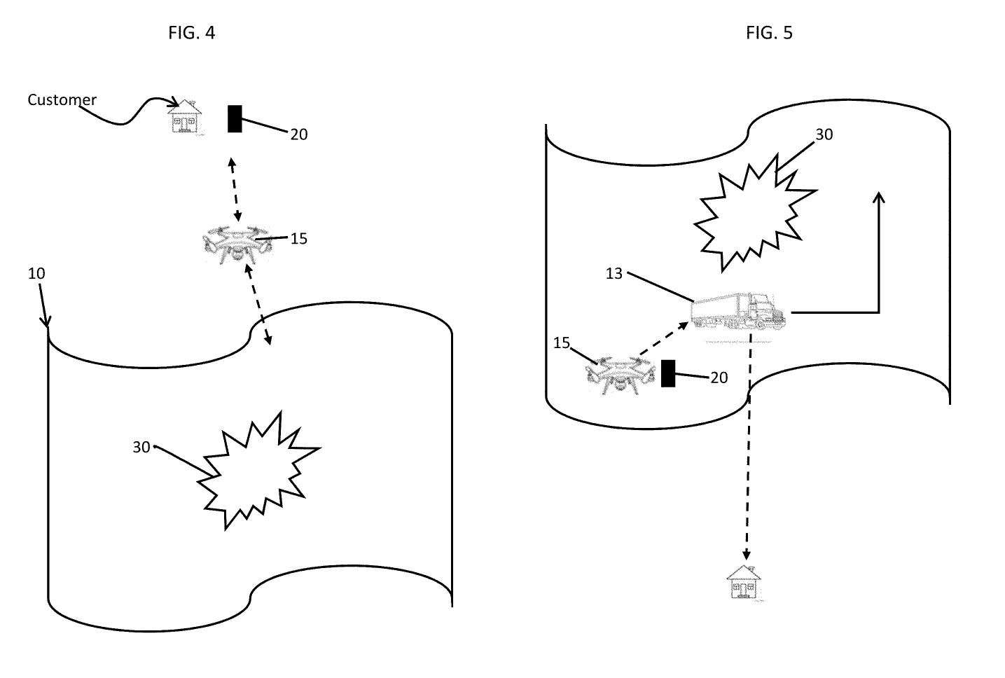

With reference to FIG. 4, a drone delivery scenario of the drone delivery system 10 is illustrated in accordance with embodiments of the invention. As shown in FIG. 4, a customer who lives in a remote region orders an item from the delivery system 10 but delivery to his home via truck would add logistical costs and the drones 15 of the delivery system 10 do not have sufficient battery life and range to fly to his home and back (this scenario is an example of substantial ‘last mile’ costs which can account for 28% of total delivery costs on average) without additional charge assistance. The customer has therefore installed a drone charging station 20 on their property which allows any drones 15 that are used to deliver items to his home to be charged prior to their return trip. The installation of the drone charging station 20 decreases costs of delivery to the delivery system 10 and earns the customer a credit as calculated by the processor 30 which can be used to defray some or all of the costs of the item or the delivery.

With reference to FIG. 5, another drone delivery scenario of the drone delivery system 10 is illustrated in accordance with embodiments of the invention. As shown in FIG. 5, the delivery system 10 is delivering items to customer's homes via a drone-carrying truck 13 but one of the items is to be delivered to a home in the opposite direction the truck 13 is driving. While this case would normally waste time and battery power, the customer has a drone charging station 20 installed on their property so that the drone 15 can recharge after delivery. The customer thus receives a shipping credit as calculated by the processor 30 in exchange for his willingness to install and permit use of his drone charging station 20. Meanwhile, once the drone 15 leaves his property, the processor 30 instructs the drone 15 to return to a different, more convenient truck 13 to save time, battery and logistical cost.

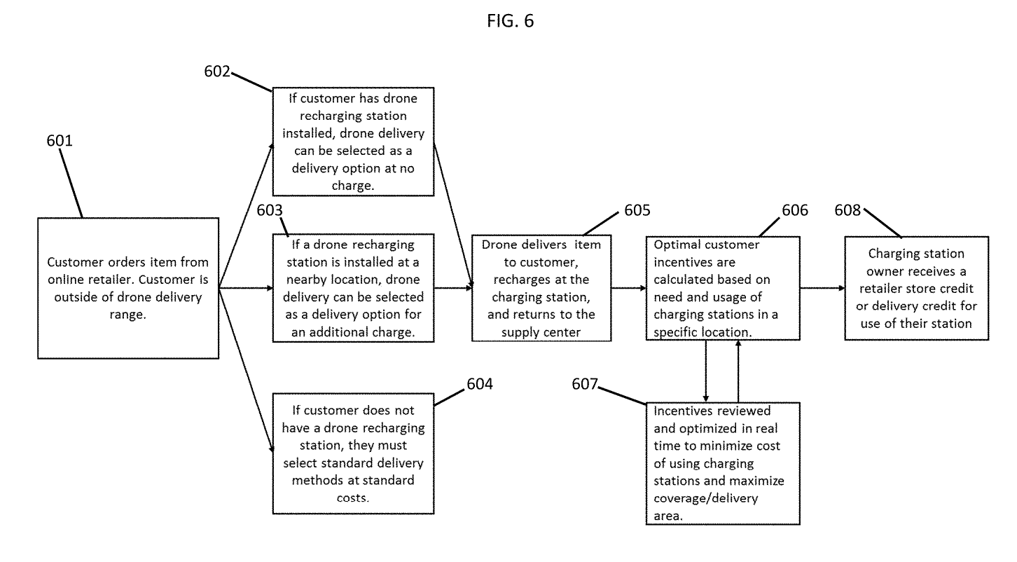

With reference to FIG. 6, a flow diagram illustrating a method of operating the drone delivery system 10 is provided. As shown in FIG. 6, a customer initially orders an item from an online retailer but it is determined by the processor 30 that the customer resides outside of the range of the delivery system 10 (601). In an event it is found, however, that the customer has a drone charging station 20 that can be used to recharge a drone which is used to deliver the item to the customer's residence, drone delivery can be selected at no additional charge (602). Meanwhile, in an event it is found that a drone charging station 20 is installed nearby and can be used to recharge a drone which is used to deliver the item to the customer's residence, drone delivery can be selected at an additional charge (603). On the other hand, if the customer does not have a drone charging station 20 and one is not available nearby, the customer must select standard delivery at standard costs (604).

Once drone delivery following operations 602 or 603 is complete, the drone 15 recharges at the customer's or the nearby drone charging station 20 and returns to a convenient base 11, warehouse 12, and truck 13 (605). At this point, customer incentives are calculated based at least on need and usage of drone charging stations 20 (606) and the calculated incentives are reviewed and optimized in real time (607). Finally, the owner of the done charging station 20 which is used to charge the drone 15 receives his incentive (608).

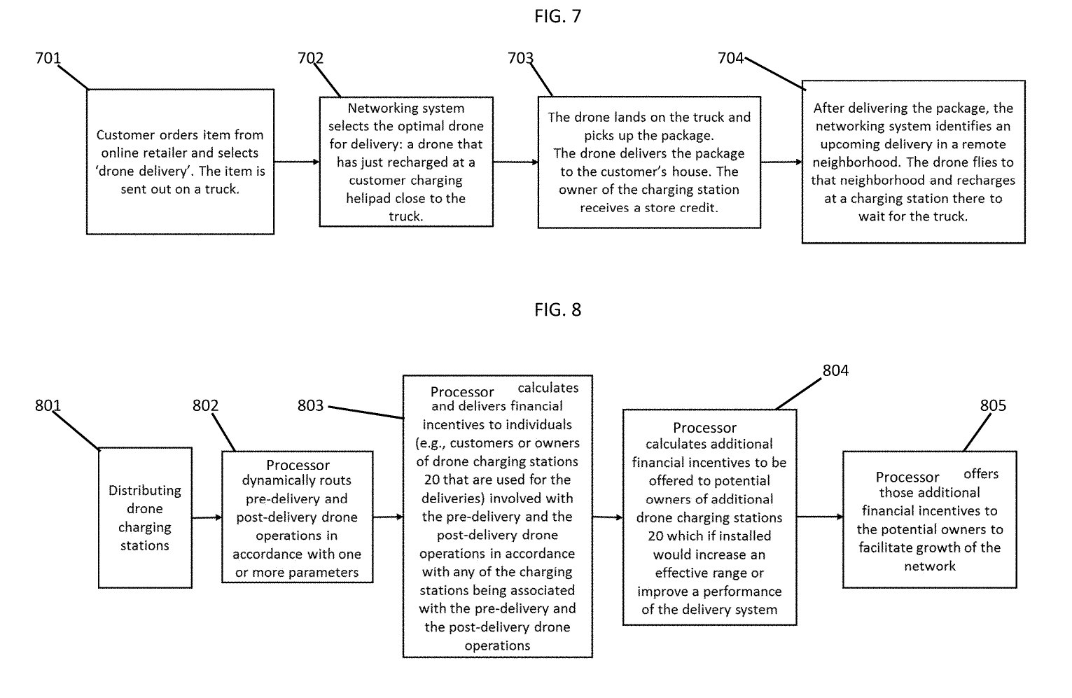

With reference to FIG. 7, a flow diagram illustrating a method of operating the drone delivery system 10 is provided. As shown in FIG. 7, a customer initially orders an item from an online retailer and selects drone delivery as an option and the delivery system 10 initially sends the item out in a delivery truck 13 (701). The drone delivery system 10 then identifies and selects an optimal drone 15 for the delivery from the truck 13 to the customer, such as a drone 15 that has just recharged at a customer's drone charging station 20 close to the truck 13 (702). The selected drone 15 subsequently lands on the truck 13, picks up the item to be delivered and delivers the item to the customer's residence and meanwhile the owner of the drone charging station 20 nearby the truck 13 receives a credit (703). After delivery is complete, the delivery system 10 identifies an upcoming delivery in a remote neighborhood and the drone 15 flies to that neighborhood and recharges at another drone charging station 20 there to wait for the truck 13 (704).

With reference to FIG. 8, a flow diagram illustrating a method of operating and growing a network of charging stations of the delivery system 10 is provided. As shown in FIG. 8, the method includes distributing drone charging stations 20 throughout the area of land serviced by the delivery system 10 (801). The processor 30 of the delivery system 10 subsequently dynamically routs pre-delivery and post-delivery drone operations in accordance with one or more parameters (802). The processor 30 also calculates and delivers financial incentives to individuals (e.g., customers or owners of drone charging stations 20 that are used for the deliveries) involved with the pre-delivery and the post-delivery drone operations in accordance with any of the charging stations being associated with the pre-delivery and the post-delivery drone operations (803). In addition, the processor 30 calculates additional financial incentives to be offered to potential owners of additional drone charging stations 20 which if installed would increase an effective range or improve a performance of the delivery system 10 (804) and offers those additional financial incentives to the potential owners to facilitate growth of the network (805).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user' s computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments of the invention, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments of the invention described. Many modifications and variations will be apparent to those of ordinary skill in the art without departing from the scope and spirit of the described embodiments of the invention. The terminology used herein was chosen to best explain the principles of the embodiments of the invention, the practical application or technical improvement over technologies found in the marketplace, or to enable others of ordinary skill in the art to understand the embodiments of the invention described herein.

What is claimed is:

1. A delivery system in which drones deliver items in a serviced area and charging stations are distributed throughout the serviced area with each charging station configured to charge one or more of the drones, the delivery system comprising:
a processor communicative with at least the charging stations and configured to:
dynamically route delivery operations of each of the drones in accordance with one or more parameters, and
communicate with individuals involved with the delivery operations in accordance with any of the charging stations being associated with the delivery operations.

2. The delivery system according to claim 1, wherein the drones are variously deployed from and variously return to bases, trucks and warehouses.

3. The delivery system according to claim 1, wherein at least the charging stations are communicative with each other via one or more of WiFi and cellular networks.

4. The delivery system according to claim 1, wherein one or more of the charging stations is modular.

5. The delivery system according to claim 1, wherein the processor comprises one or more of computing resources distributed throughout at least the charging stations and a central server.

6. The delivery system according to claim 1, wherein the delivery operations comprise pre-delivery and post-delivery drone travel.

7. The delivery system according to claim 1, wherein:
the one or more parameters comprise cost minimization and productivity maximization parameters, and
communication between the processor and the individuals comprises deliveries of financial incentives calculated in accordance with charging station value in the serviced area.

8. The delivery system according to claim 1, wherein the processor is further configured to:
calculate additional financial incentives to be offered to potential owners of additional charging stations; and
offer the additional financial incentives to the potential owners to facilitate growth of the network.

9. An item delivery system, comprising:
drones configured to deliver items to customers residing in a serviced area;
a network of communicative charging stations distributed throughout the serviced area, each charging station being configured to charge one or more of each of the drones; and
a processor comprising one or more of computing resources distributed throughout at least the charging stations and a central server, the processor being communicative with at least the charging stations and configured to:
dynamically route pre-delivery and post-delivery operations of each of the drones in accordance with one or more parameters, and
communicate with individuals involved with the pre-delivery and the post-delivery operations and with operators of at least a portion of those charging stations which are associated with the pre-delivery and the post-delivery operations.

10. The delivery system according to claim 9, further comprising bases, trucks and warehouses from which the drones are variously deployed and to which the drones variously return.

11. The delivery system according to claim 9, wherein the charging stations are communicative via one or more of WiFi and cellular networks.

12. The delivery system according to claim 9, wherein one or more of the charging stations is modular.

13. The delivery system according to claim 9, wherein:
the one or more parameters comprise cost minimization and productivity maximization parameters, and
communication between the processor and the individuals and the operators comprises deliveries of financial incentives calculated in accordance with charging station value in the serviced area.

14. The delivery system according to claim 9, wherein the processor is further configured to:
calculate additional financial incentives to be offered to potential owners of additional charging stations; and
offer the additional financial incentives to the potential owners to facilitate growth of the network.

15. A method of operating an item delivery system in which drones deliver items in a serviced area, charging stations are distributed throughout the serviced area with each charging station being configured to charge one or more of each of the drones and a processor is communicative with at least the charging stations,
the method being executable by the processor and comprising:
dynamically routing pre-delivery and post-delivery operations of each of the drones in accordance with one or more parameters; and
communicating with individuals involved with the pre-delivery and the post-delivery operations in accordance with any of the charging stations being associated with the pre-delivery and the post-delivery operations.

16. The method according to claim 15, further comprising:
variously deploying the drones from bases, trucks and warehouses; and
variously returning the drones to the bases, trucks and warehouses.

17. The method according to claim 15, further comprising establishing communications between at least the charging stations and a central server via one or more of WiFi and cellular networks.

18. The method according to claim 15, wherein:
the one or more parameters comprise cost minimization and productivity maximization parameters, and
the communicating comprises delivering financial incentives calculated in accordance with charging station value in the serviced area.

19. The method according to claim 15, wherein the method further comprises:
calculating additional financial incentives to be offered to potential owners of additional charging stations; and
offering the additional financial incentives to the potential owners to facilitate growth of the network.

20. A computer program product for operating an item delivery system in which drones deliver items in a serviced area and charging stations are distributed throughout the serviced area with each charging station being configured to charge one or more of each of the drones, the computer program product comprising:
memory on which executable instructions are stored; and
a processing circuit which is communicative with at least the charging stations and configured to execute the executable instructions to perform a method comprising:
dynamically routing pre-delivery and post-delivery operations of each of the drones in accordance with one or more parameters; and
communicating with individuals involved with the pre-delivery and the post-delivery operations in accordance with any of the charging stations associated with the pre-delivery and the post-delivery operations.

21. The computer program product according to claim 20, further comprising:
variously deploying the drones from bases, trucks and warehouses; and
variously returning the drones to the bases, trucks and warehouses.

22. The computer program product according to claim 20, further comprising establishing communications between at least the charging stations and a central server via one or more of WiFi and cellular networks.

23. The computer program product according to claim 20, wherein:
the one or more parameters comprise cost minimization and productivity maximization parameters, and
the communicating comprises delivering financial incentives calculates in accordance with charging station value in the serviced area.

24. The computer program product according to claim 20, wherein the method further comprises:
calculating additional financial incentives to be offered to potential owners of additional charging stations; and
offering the additional financial incentives to the potential owners to facilitate growth of the network.

25. A method of operating and growing a network of charging stations for a drone delivery system, the method comprising:
distributing charging stations throughout an area serviced by the drone delivery system;
dynamically routing pre-delivery and post-delivery drone operations in accordance with one or more parameters;
delivering financial incentives to individuals involved with the pre-delivery and the post-delivery drone operations in accordance with any of the charging stations associated with the pre-delivery and the post-delivery drone operations;
calculating additional financial incentives to be offered to potential owners of additional charging stations which can increase an effective range or improve a performance of the drone delivery system; and
offering the additional financial incentives to the potential owners to facilitate growth of the network.
